(19) United States
(12) Patent Application Publication
(10) Pub. No.: US 2014/0282322 A1
(43) Pub. Date: Sep. 18, 2014

(54) SYSTEM AND METHOD FOR FILTRATION OF ERROR REPORTS RESPECTIVE OF STATIC AND QUASI-STATIC SIGNALS WITHIN AN INTEGRATED CIRCUIT DESIGN

(71) Applicant: ATRENTA, INC., San Jose, CA (US)

(72) Inventors: Mohamed Shaker Sarwary, San Diego, CA (US); Maher Mneimneh, San Jose, CA (US); Paras Mal Jain, Greater Noida (IN); Mohammad H. Movahed-Ezazi, Saratoga, CA (US); Jean P. Binois, Boulogne (FR)

(73) Assignee: Atrenta, Inc., San Jose, CA (US)

(21) Appl. No.: 13/872,303

(22) Filed: Apr. 29, 2013

Related U.S. Application Data
(60) Provisional application No. 61/786,671, filed on Mar. 15, 2013.

(51) Int. Cl. G06F 17/50

(52) U.S. Cl. CPC G06F 17/5045
USPC 716/108

(57) ABSTRACT

A system and method identify potentially static and/or quasi-static signals within an integrated circuit (IC), or portion thereof. Static and quasi-static signals may be identified in a design description of the IC by any one or more of: (1) a fan-out size exceeding some threshold, (2) a toggle frequency in a simulation trace that is below some threshold, and (3) a signal name that appears in a list accessed from the memory. Identification of static and quasi-static signals is performed, typically, as part of a verification process in order to flag cases where the verification system would otherwise indicate an error (e.g., at a clock domain crossing). Identifying a signal of the IC as being static or quasi-static improves the quality of results of verification and makes it easier for a prospective user to concentrate on actual rather than spurious issues reported during verification.

### CROSS-REFERENCE TO RELATED APPLICATION

The present application claims priority under 35 U.S.C. 119(e) from prior U.S. Provisional Application No. 61/786,671, filed on Mar. 15, 2013.

### TECHNICAL FIELD

The invention generally relates to integrated circuit (IC) verification and more particularly to IC verification involving static and quasi-static signals.

### BACKGROUND ART

A challenge of applying static analysis to integrated circuit (IC) designs is the existence of information that is available, or otherwise known, to the user but not to the verification system. As a result, incorrect violations are reported as the verification system cannot infer or understand such knowledge possessed by the designer. Correctly handling static and quasi-static signals of an IC is one common example. A static signal is a signal that never changes values while a quasi-static signal is a signal that changes value infrequently and under specific conditions. When these signals are not provided as an input to the verification system, some reported violations related to such signals are incorrect. The user usually waives such violations knowing that such signals are static or quasi-static. Incorrect analysis in the presence of static and quasi-static signals is typical when performing clock domain crossing (CDC) verification. As ICs become larger, the number of static and quasi-static signals increases. As a result, the manual step of reviewing these violations decreases the productivity of the user and makes it more difficult to achieve design verification closure.

It would be therefore advantageous to provide a system and method that overcome the limitations of prior art. Specifically, it would be advantageous if the system could automatically identify static and quasi-static signals in IC designs and use this information when reporting violations to the user.

### SUMMARY DISCLOSURE

A method implemented in a computing system is provided for the identification of static signals or quasi-static signals of an integrated circuit in a design verification of such a circuit. The method begins by receiving a description of the design of at least a portion of the circuit. The description may be provided in a register transfer level (RTL) language. Then, any one or more signals having a specified characteristic of a static signal or a quasi-static signal are identified from the received description. The identification of any one or more signals may be carried out, for example, by filtering candidate signals in the received description that are involved in a clock domain crossing (CDC) or a timing exception. The specified characteristic of a static or quasi-static signal may be selected from any one or more of: (1) a fan-out size exceeding a specified threshold fan-outsize; (2) a toggle frequency in a simulation trace that is below a specified threshold frequency; and (3) a signal name in the received description that appears in a specified list accessed from the memory.

A listing of any such identified signal or signals is stored in a memory. In verifying a design for the integrated circuit, after receiving an error report from a verification program that checked the circuit, a filtering process may be performed using the listing to match errors in the error report with any signals that have been identified as static or quasi-static. One can either (1) eliminate from the error report any errors respective of signals appearing in the listing, or (2) reorder the error report such that errors respective of signals appearing in the listing appear in a separate section from all other errors. In either case, a revised report may then be stored in memory.

A programmable system for the identification of static signals and quasi-static signals of an integrated circuit as part of design verification of the circuit is provided. The system includes a processing unit and a memory coupled to the processing unit. The memory contains program instructions that when executed by the processing unit configure the system to carry out the aforementioned method steps, namely to receive a description of the design of at least a portion of the circuit; identify from the received description any one or more signals having a specified characteristic of a static signal or a quasi-static signal; and, store a listing in a memory respective of any such identified signal.

### BRIEF DESCRIPTION OF THE DRAWINGS

FIG. 1 is a flowchart of a computerized method for identifying static and quasi static signals of an IC design according to an embodiment.

FIG. 2 is a flowchart of a computerized method for filtering violation reports of a verification system after the identification of static and quasi-static signals according to an embodiment.

FIG. 3 is a system for identifying static or quasi-static signals of an IC design implemented according to an embodiment.

### DETAILED DESCRIPTION

A system and method identify potentially static and/or quasi-static signals within an integrated circuit (IC), or portion thereof. This is performed, typically, as part of a verification process in order to flag cases where the verification system would otherwise indicate an error, for example at a clock domain crossing (CDC). Identifying a signal of the IC as being static or quasi-static improves the quality of results of verification and makes it easier for a prospective user to concentrate on actual rather than spurious issues reported during verification.

One of ordinary skill in the art would readily appreciate that identifying static and quasi-static signals is advantageous for static analysis. For example, in CDC analysis, identifying that the source flop of a clock domain crossing has a static, or quasi-static, behavior eliminates the need to synchronize this flop to the destination clock domain. Similarly, it is beneficial to identify static signals or quasi-static signals in timing exception verification. An event where a signal changes its value may propagate through several stages. However, if the signal is static or quasi-static, such an event will not happen and therefore no event will propagate making a path a valid false path or a valid multi-cycle path. Without this knowledge an exception verification tool would incorrectly point such timing exception as an incorrect timing exception. This leads to an additional burden on the designer verifying the circuit being checked.

There are several methods to identify static signal or quasi-static signals. Typically the number of fan-outs of such signals is very high. This is due to the fact that these are usually control signals such as configuration registers that control various part of the IC design, or portions thereof. Since these signals change infrequently, there is no need to synchronize them as they cross into different domains.

FIG. 1 is an exemplary and non-limiting flowchart 100 of a computerized method of identifying static or quasi-static signals of a circuit (i.e., an IC or a portion thereof) according to an embodiment. In S110 a circuit such as a design of an IC, or a portion thereof, is received in, for example, in a register transfer language (RTL). In S120 all signals of the circuit are identified, for example, but not by way of limitation, by listing all the FFs driving the signals therein for future reference. In S130 a signal not previously selected for checking is selected as next to be checked. This selection may be further filtered to consider application specific requirement. For example, for CDC, only signals crossing clock domains may be selected as those are the target for CDC verification, while for timing exception verification, only signals involved in a timing exception or control of the timing exception can be selected for the analysis. In S140 the number of fan-outs for the selected signal is checked, as according to one embodiment of the invention this is a strong indicator of a signal being a static or quasi-static. In S150 the number of fan-outs is compared against a predetermined threshold and if the number is larger than the threshold value execution continues with S160; otherwise, execution continues with S170. In S160 a report is generated identifying the selected signal as a static or quasi-static signal. In S170 it is checked whether additional signals are to be checked and if so, execution continues with S130; otherwise, execution terminates. One of ordinary skill in the art would appreciate that the block 110 in flowchart 100, with S140 and S150 may be replaced by other ways of identification of static or quasi-static signals. For example, it is possible, in one embodiment, to check a simulation trace of a large enough number of cycles to determine how frequently a signal toggles to determine if it is to be considered dynamic (i.e., a large number of toggles), quasi-static (i.e., a limited number of toggles) or static (i.e., no toggles). In another embodiment of the invention block 110 may be replaced by a mechanism that analyzes signal names as typically names such as “CFG”, “CONFIG”, “STATUS” and others are indicative of a signal being at least quasi-static. Such a list of names may be stored in a database and the signal name being checked compared against the database. In one embodiment a plurality of different verification methods may be used for each signal.

FIG. 2 is an exemplary and non-limiting flowchart 200 of a computerized method for filtering error reports receiving from a verification program to identify static of quasi-static signals according to an embodiment. In S210 a first report is received with a list of the suspected static and quasi-static signals. In S220 a second report is received from a verification program typically used for verification of an IC or portion thereof, which contains one or more error reports respective to signals of the IC. In S230 a filtering process takes place where each signal of an error reported in the second report is checked against the first report. In one embodiment of the invention, a report is provided in S240 where such signals are eliminated in a filtered report. In another embodiment of the invention a report is provided in S240 where the errors related to signals identified in the second report as being associated with a static or quasi-static signal of the first report, are listed separately from the errors not belonging to this category.

FIG. 3 depicts an exemplary and non-limiting system 300, such as a computer aided design (CAD) system, implemented according to an embodiment. The system 300 comprises a processing element 310, for example, a central processing unit (CPU), that is coupled by a bus 205 to a memory 320. The memory 320 further comprises a memory portion 322 that contains instructions that when executed by the processing element 310 performs the methods described in more detail herein. The memory may be further used as a working scratch pad for the processing element 310, a temporary storage, and others, as the case may be. The memory may comprise of volatile memory such as, but not limited to random access memory (RAM), or non-volatile memory (NVM), such as, but not limited to, flash memory. Memory 320 may further comprise a memory portion 324 containing data respective of a circuit containing at least one static and/or at least one quasi-static signal. The processing element 310 may be coupled to a display unit 340, e.g., a computer screen, an input device 350, e.g., a mouse and/or a keyboard, and a data storage 330. Data storage 330 may be used for the purpose of holding a copy of the instructions for the methods executed in accordance with the disclosed technique. Data storage 330 may further comprise storage portion 235 containing a description of a circuit, such as an IC, or portion thereof, for example in RTL, including its sub-circuits discussed hereinabove, and the signals discussed thereto.

The principles of the invention are implemented as hardware, firmware, software or any combination thereof, including but not limited to a CAD system and software products thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit and/or display unit.

What is claimed is:

1. A method implemented in a computing system for identification of static signals or quasi-static signals of a circuit, the method comprising:
receiving a description of the design of at least a portion of the circuit;
identifying from the received description any one or more signals having a specified characteristic of a static signal or a quasi-static signal; and
storing a listing in a memory of any such identified signal.

2. The method of claim 1, wherein the description of the circuit is provided in a register transfer level (RTL) language.

3. The method of claim 1, wherein the specified characteristic is selected from any one or more of: a fan-out size exceeding a specified threshold fan-out size; a toggle frequency in a simulation trace that is below a specified threshold frequency; and a signal name in the received description that appears in a specified list accessed from the memory.

4. The method of claim 1, wherein the identification of any one or more signals further comprises filtering candidate signals in the received description that are involved in one of a clock domain crossing (CDC) and a timing exception.

5. The method of claim 1, wherein identifying any one or more signals further comprises:
identifying from the received description all elements in a sub-circuit of the circuit driven by a candidate signal;
determining a fan-out size of the candidate signal; and
identifying a candidate signal as a static signal or a quasi-static signal if the fan-out size is above a predetermined threshold value.

6. The method of claim 1, wherein identifying any one or more signals further comprises:
receiving a simulation trace for the circuit design;
determining for each signal in the simulation trace a number of toggles from one state to another state;
identifying any signal having a number of toggles below a predetermined threshold as a quasi-static signal; and
identifying any signal having zero toggles as a static signal.

7. The method of claim 1, wherein identifying any one or more signals further comprises:
identifying from the received description at least one unsynchronized signal that crosses a clock domain;
determining a fan-out of each identified unsynchronized signal that crosses a clock domain; and
identifying any unsynchronized signal that crosses a clock domain as a static signal if the fan-out exceeds a first threshold value or as a quasi-static signal if the fan-out exceeds a second threshold value, the second threshold value being smaller than the first threshold value.

8. The method of claim 1, wherein identifying any one or more signals further comprises:
extracting a name respective of each signal in the received description;
comparing the name to a database of signal names, the signal names in the database belonging to one of two groups: static and quasi-static;
determining whether the name of any signal in the received description appears in one of the two groups in the database; and
identifying any signal in the received description whose name appears in the static group of signal names as a static signal and any signal in the received description whose name appears in the quasi-static group of signal names as a quasi-static signal.

9. The method of claim 1, further comprising:
receiving an error report from a verification program that checked the circuit; and
performing a filtering process to match between errors in the error report and signals identified as static or quasi-static.

10. The method of claim 9, further comprising:
eliminating from the report each error reported respective signals that appear in the listing; and
storing a revised report of the error report in memory.

11. The method of claim 9, further comprising:
reordering the error report such that each error reported respective of a signal in the listing so that all signals that appear in the listing appear in one section of a revised report and all other signals reported in the error report and not in the listing appear in a second section; and
storing the revised report of the error report in memory.

12. A computing system for identification of static signals or quasi-static signals of an integrated circuit as part of a design verification of the circuit, the system comprising:
a processing unit;
a memory coupled to the processing unit, the memory containing instructions that when executed by the processing unit configure the processing unit to: receive a description of the design of at least a portion of the circuit; identify from the received description any one or more signals having a specified characteristic of a static signal or a quasi-static signal; and, store a listing in a memory respective of any such identified signal.

13. The system of claim 12, wherein the description of the circuit is provided in a register transfer level (RTL) language.

14. The system of claim 12, wherein the specified characteristic is selected from any one or more of: a fan-out size exceeding a specified threshold fan-out size; a toggle frequency in a simulation trace that is below a specified; threshold frequency; and a signal name in the received description that appears in a specified list accessed from the memory.

15. The system of claim 12, wherein the memory further contains instructions that further configure the identification of any signals to: filter candidate signals in the received description that are involved in one of a clock domain crossing (CDC) and a timing exception.

16. The system of claim 12, wherein the memory further contains instructions that further configure the identification of any signals to: identify from the received description all elements in a sub-circuit of the circuit driven by candidate signal; determine a fan-out size of the candidate signal; and identify a candidate signal as a static signal or a quasi-static signal if the fan-out size is above a predetermined threshold value.

17. The system of claim 12, wherein the memory further contains instructions that further configure the identification of any signals to: receive a simulation trace for the circuit design; determine for each signal in the simulation trace a number of toggles from one state to another state; identify any signal having a number of toggles below a predetermined threshold as a quasi-static signal; and, identify any signal having zero toggles as a static signal.

18. The system of claim 12, wherein the memory further contains instructions that further configure the identification of any signals to: identify from the received description at least one unsynchronized signal that crosses a clock domain; determine a fan-out of each identified unsynchronized signal that crosses a clock domain; and, identify any unsynchronized signal that crosses a clock domain as a static signal if the fan-out exceeds a first threshold value or as a quasi-static signal if the fan-out exceeds a second threshold value, the second threshold value being smaller than the first threshold value.

19. The system of claim 12, wherein the memory further contains instructions that further configure the identification of any signals to: extract a name respective of each signal in the received description; compare the name to a database of signal names, the database coupled to the processing unit, the signal names belonging to one of two groups: static and quasi-static; determine whether the name of any signal in the received description appears in one of the two groups in the database; and, identify any signal in the received description whose name appears in the static group of signal names as a static signal and any signal in the received description whose name appears in the quasi-static group of signal names as a quasi-static signal.

20. The system of claim 12, wherein the memory further contains instructions that when executed by the processing unit configure the system to: receive an error report from a verification program that checked the circuit; and, perform a filtering process to match between errors in the error report and signals identified as static or quasi-static.

21. The system of claim 20, wherein the memory further contains instructions that when executed by the processing unit configure the system to: eliminate from the error report each error reported respective signals that appear in the listing; and, store a revised error report of the error report in memory.

22. The system of claim 20, wherein the memory further contains instructions that when executed by the processing unit configure the system to: reorder the error report such that each error reported respective of a signal in the listing so that all signals that appear in the listing appear in one section of a revised report and all other signals reported in the error report and not in the listing appear in a second section; and, store the revised report of the error report in memory.

23. The system of claim 12, wherein the system is a computer aided design (CAD) system.
